(19) United States
(12) Patent Application Publication
(10) Pub. No.: US 2013/0311967 A1
(43) Pub. Date: Nov. 21, 2013

(54) Method and System for Collapsing Functional Similarities and Consolidating Functionally Similar, Interacting Systems

(71) Applicant: WELLPOINT, INC., Chicago, IL (US)

(72) Inventors: Atul Apte, North Las Vegas, NV (US); Rickey Tang, Southwick, MA (US)

(21) Appl. No.: 13/894,641

(22) Filed: May 15, 2013

Related U.S. Application Data
(60) Provisional application No. 61/647,663, filed on May 16, 2012.
(60) Provisional application No. 61/775,890, filed on Mar. 11, 2013.

(51) Int. Cl. G06F 9/44

(52) U.S. Cl. CPC G06F 8/00
USPC 717/100

(57) ABSTRACT

Data identifying two or more functionally similar systems is received. Functional similarities across the two or more functionally similar systems are identified. The functional similarities are grouped into one or more categories. A proportion of each of the grouped functional similarities relative to each of the two or more functionally similar systems is measured. Based on the proportion of each of the grouped functional similarities, a non-redundant system comprising at least some functionality from each of the two or more functionally similar systems is identified.

### CROSS REFERENCE TO RELATED APPLICATIONS

This application claims priority to U.S. Provisional Patent Application Nos. 61/647,663, filed May 16, 2012, and 61/775,890, filed Mar. 11, 2013, the entireties of which are incorporated herein by reference.

### TECHNICAL FIELD

This invention relates to consolidating functionally similar, interacting systems.

### SUMMARY

The present invention relates to a method, system and non-transitory computer readable medium for consolidating functionally similar systems. Data identifying two or more functionally similar systems is received. Functional similarities across the two or more functionally similar systems are identified. The functional similarities are grouped into one or more categories. A proportion of each of the grouped functional similarities relative to each of the two or more functionally similar systems is measured. Based on the proportion of each of the grouped functional similarities, a non-redundant system comprising at least some functionality from each of the two or more functionally similar systems is identified.

In some embodiments, the categories include system interfaces, system-generated transactions, system dependencies, system services, and/or system processes.

In some embodiments, the system dependencies include inbound functional dependency, outbound functional dependency, or bi-directional functional dependency.

### BRIEF DESCRIPTION OF THE DRAWINGS

The foregoing summary, as well as the following detailed description of various embodiments, will be better understood when read in conjunction with the appended drawings. It should be understood, however, that the invention is not limited to the precise arrangements and instrumentalities shown.

FIG. 1 is a diagram illustrating an example of relative functionally similar and functionally different systems;

FIG. 2 is a diagram illustrating a proposed merging of more than two functionally similar systems;

FIG. 3 is a diagram illustrating an example of an abstraction model of a system that may be used in connection with the methodologies of the present invention;

FIG. 4 is a diagram illustrating a manner in which a capability footprint for a system may be generated;

FIG. 5A illustrates three exemplary systems, the inputs they receive, the functionality they perform, and their outputs;

FIG. 5B illustrates three exemplary scenarios for collapsing the exemplary systems of FIG. 5A;

FIG. 6 illustrates detecting relative functional similarities and differences in three exemplary systems;

FIG. 7 illustrates an exemplary process for collapsing functionally similar systems;

FIG. 8 illustrates an exemplary process for merging functionally similar systems;

FIG. 9 illustrates the benefits of collapsing functionally similar systems;

FIG. 10 illustrates the complexities of merging functionally similar systems;

FIG. 11 illustrates non-redundancy in collapsed functionally similar systems; and

FIG. 12 is a diagram illustrating an exemplary system that may be used in connection with carrying out embodiments of the present invention.

### DETAILED DESCRIPTION

The two most commonly used system consolidation methods include:
1) Merging two or more functionally similar systems into one combined (merged) system; and
2) Replacing one or more functionally similar systems with a new functionally equivalent enhanced system.

The technical and economic feasibility of merging more than two functionally similar systems increases exponentially with the number of systems sought to be merged. Replacing more than one functionally similar system requires significantly long migration timelines. Existing functional decomposition methods identify discrete (non-redundant) functions within a non-interacting system. However, most contemporary system interacts with one or more legacy or contemporary systems. Hence, using existing functional decomposition methods becomes challenging especially as the number of functionally similar systems increases (e.g., is greater than 2).

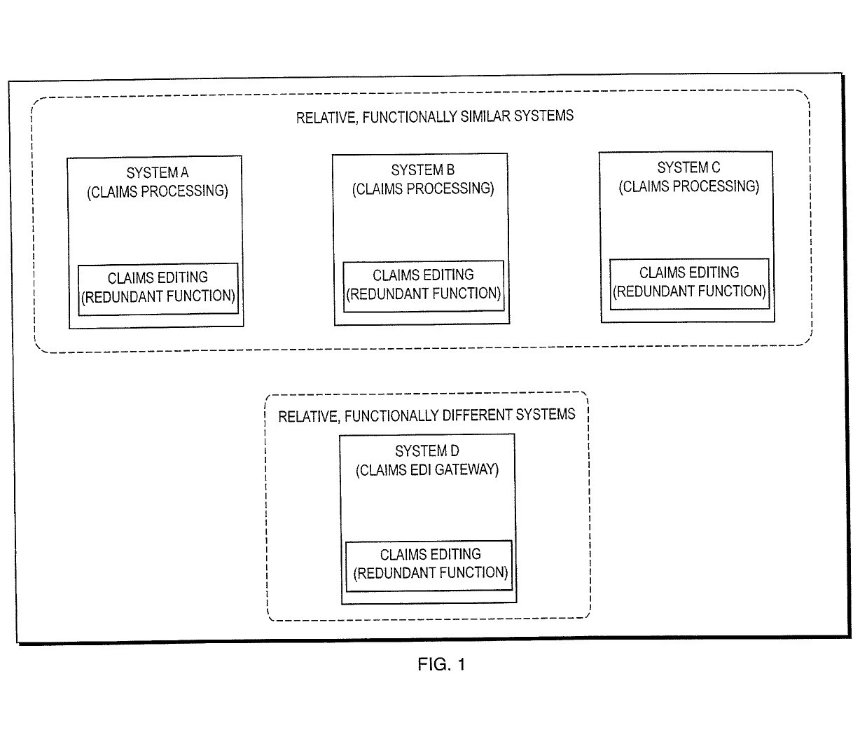

FIG. 1 is an example of relative functionally similar and different systems. In the illustrated example, Systems A, B, and C are relatively functionally similar, as their primary function is insurance claims processing. System D has similar functionality (claims editing) but the primary function of System D is different from primary functions of Systems A, B, and C.

The disclosed system consolidation method identifies and eliminates redundancies within functionally similar systems and the result is a set of functionally different (unique) interacting systems.

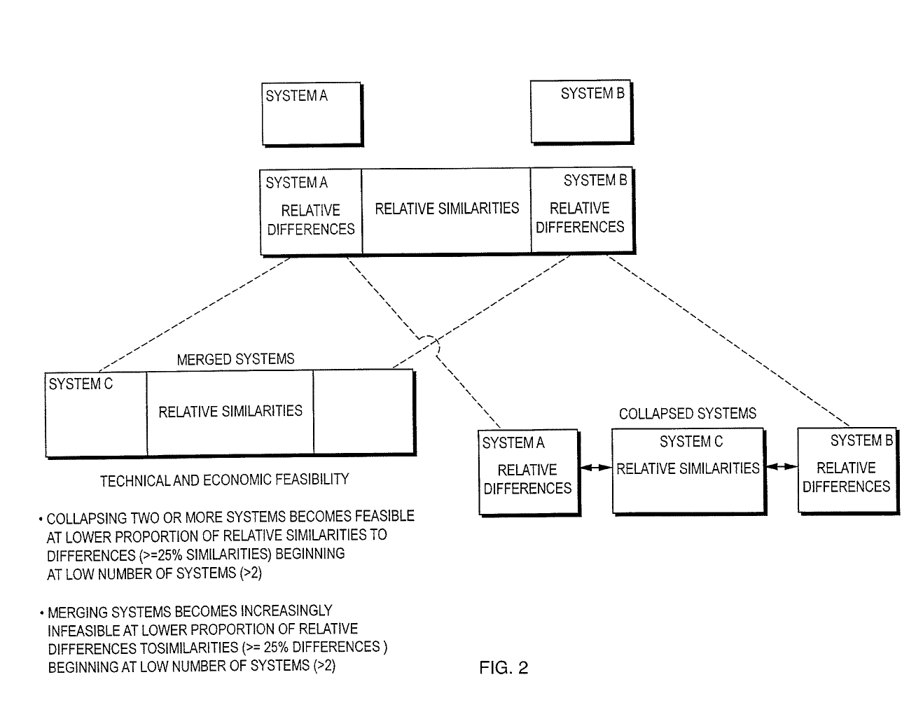

Consolidation of functionally similar systems is an exponentially complex problem. With increasing numbers of functionally similar systems, the complexity of consolidating relative similarities and relative differences leads to infeasible implementations. FIG. 2 illustrates the challenges of merging two or more functionally similar systems.

FIG. 2 also illustrates the results of the disclosed method for collapsing and consolidating functionally similar systems. One of the methods disclosed herein consolidates relative functional similarities and isolates relative functional differences. The resulting set of systems is highly non-redundant and therefore significantly more efficient.

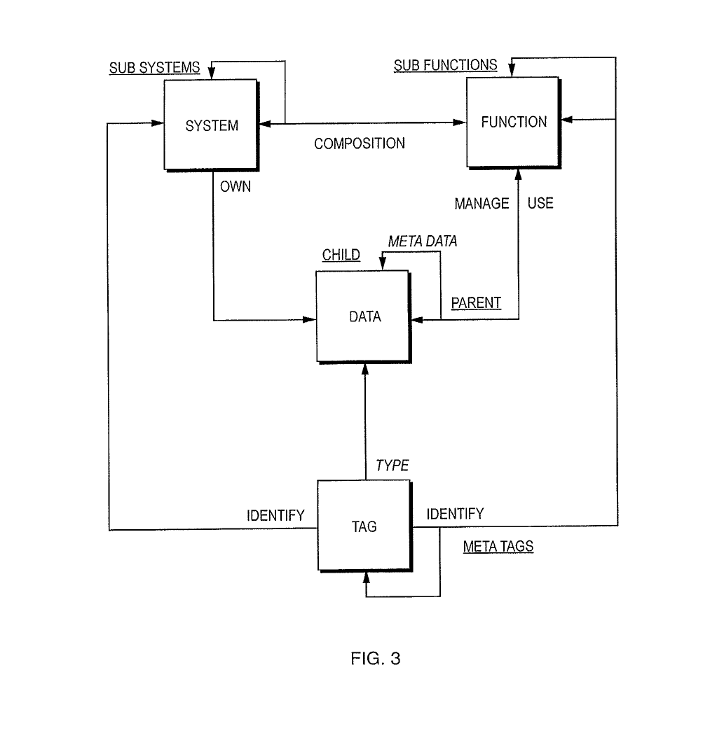

The basis for the system consolidation method described herein includes a system model capable of representing any known system. In the context of this model, a system represents anything capable of performing one or many functions. FIG. 3 illustrates the four primary elements of the abstract model and their relationships. This model is able to represent large systems (clusters of functionally similar or functionally different systems) and small systems (components of a system such as interfaces, dependencies, transactions, services, and processes). The model is useful in detecting functional redundancies across all types and granularity of systems.

The following provides definitions and examples of primary elements in the highest abstraction model. Any entity that performs one or more functions is a system. A system can have a hierarchical relationship with other systems. This hierarchical relationship can represent multiple levels of dependent or independent systems. For example, provider data administration is a system for administration of provider data. Provider demographic administration and provider credentialing are sub systems of data administration systems.

Any discrete performance unit that consumes and/or produces data is a function. A function can have a hierarchical relationship with other functions. This hierarchical relationship can represent multiple levels of dependent or independent functions. For example, provider demographic maintenance function is a performance unit that consumes any existing provider demographic data and produces updated version of provider demographic data. Physical address verification is a sub function of provider demographic maintenance function.

Any human or machine understandable representation of the result of a system's function is data. Data can have a hierarchical relationship with other data. This hierarchical relationship can represent multiple levels of dependent or independent data in a parent-child relationship. Specialization of parent-child relationship such as meta data relationships (data of data) is an example of hierarchical relationship between data.

Any sub type of data with a specific role of identifying a system, function, or data is a tag. A tag can have a hierarchical relationship with other tags. This hierarchical relationship can represent multiple levels of tags. For example, a provider may have multiple provider identifications (IDs) such as a global provider ID that uniquely identifies the provider across payers and geographic and a payer specific provider ID that uniquely identifies the provider within the context of a specific payer.

The abstract model captures and highlights the impacts of consolidating and eliminating functional redundancies in functionally similar systems. Eliminating functional redundancy impacts associated data (data managed and used by redundant function) and tags (identifiers used to identify the redundant function and the associated data).

The highest abstraction model of systems captures the fundamental associations between primary elements. These associations are types of relationships between the elements.

A system is composed of one or many functions and the performance of a function may depend on one or many systems. This bi-directional compositional association between system and function is constrained by one rule that the association system and function should be at different levels of hierarchy. A system maintains exclusive ownership of data managed and/or used by its associated functions. Maintenance and use of data is only possible by a function. A tag provides identity to systems, functions, and data. Without a tag, none of the primary elements can be identified.

The method for consolidating functionally similar systems involves detection of relative functional similarities between two or more functionally similar systems. The process of detecting relative functional similarities between functionally similar systems is based on several factors including the following, in one embodiment:

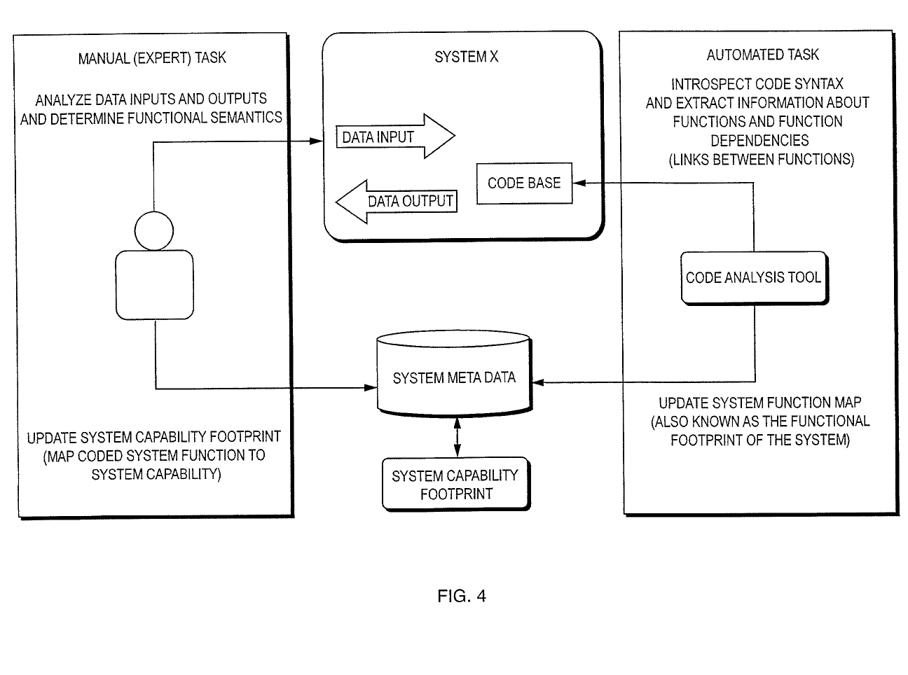

1. Information of the functional structure of a system is needed to understand the componentization of the system's functions. Some functions may be highly componentized, whereas other functions may be highly dependent on other functions. Introspection can be performed on the code of a system, from a syntax perspective, to identify the parts of the system logic that are coded as a function. Thus, code introspection allows for extracting useful information about how a function is componentized and the dependencies between components. This information helps in traversing (i.e., finding all the components that link together to complete a function) a particular function within one system or across multiple systems. Determination of structural similarity is possible by comparing componentization of functions across systems. FIG. 4 is a diagram illustrating the tasks (one or more of which may be manual and one or more of which may be automated/carried out by computer software) involved in establishing a capability footprint for a system X. In this example, System X is a claims processing system of which there can be several different implementations: A complete claims management platform, or a specific claims adjudication system or a claims editing engine. Developing the system capability footprint for all three implementations is necessary for identifying the right approach for collapsing all three implementing and eliminating functional redundancy.

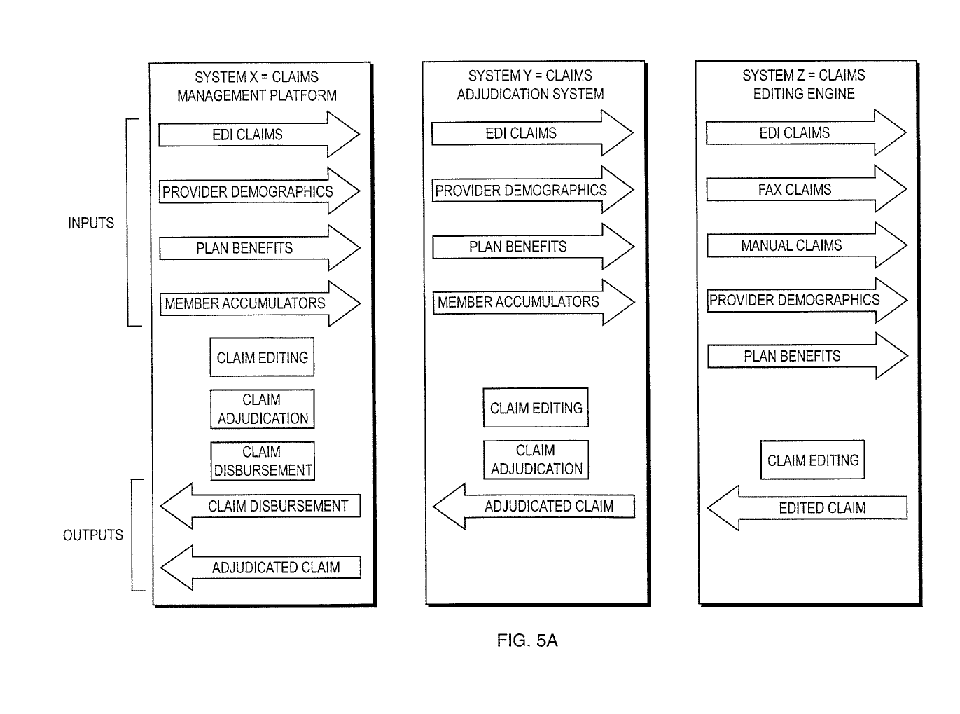

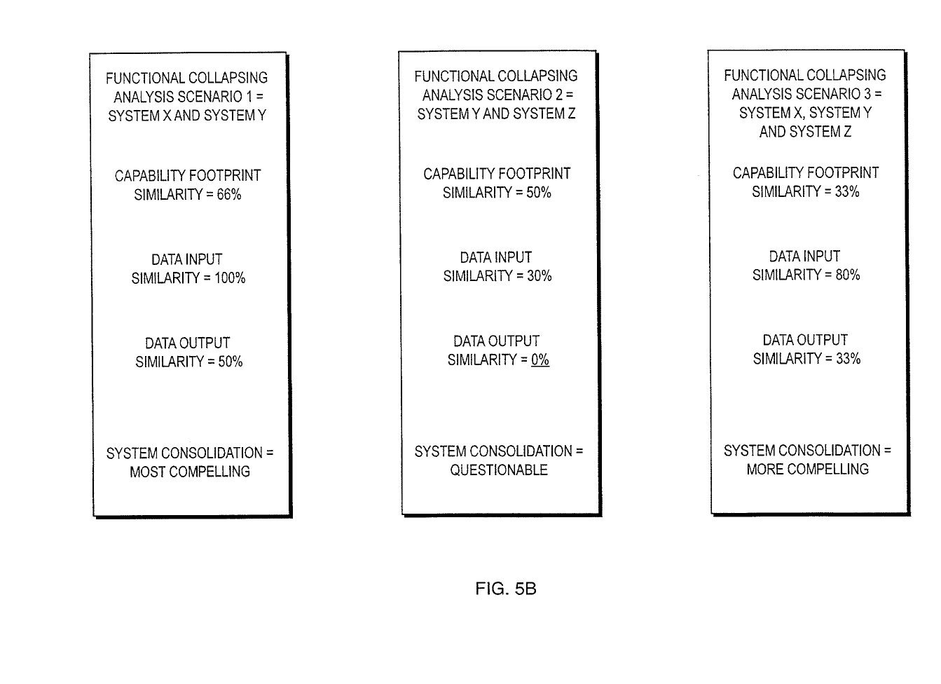

2. Information regarding functions that consume and/or produce the same data is also important in detecting potential similarities. Functions that consume and produce the same data tend to have the highest functional similarities (trending to 100% functional similarity). Functions that only produce the same data tend to have moderate functional similarities (trending to >=50% functional similarity). Functions that only consume the same data tend to have high behavior similarities but low functional similarities (trending to <=50% functional similarity). Behavioral similarity of two or more systems refers to common or similar semantics between systems, but differences in function syntax. For example, with reference to FIGS. 5A and 5B, System X and System Z have similar data inputs but System X does not have the same output as System Z. This means that although semantically System X and System Z both have claims editing capability, the function is implemented very differently as indicated by the syntax in terms of inputs and outputs. Functional similarity is determined by calculating the relative functional similarity ratio (%). Relativity depends on the function collapsing scenario. For example, with reference to FIG. 5B, Scenario 1 could involve System X and System Y, Scenario 2 could involve System Y and System Z, and Scenario 3 could involve Systems X, Y, and Z. The result of the three scenarios (i.e., the functionally collapsed systems) is potentially different. In Scenario 1 for example, the data inputs are similar, but capability footprint is different and the output is partially different (100% similar inputs, 50% similar outputs, 66% similar capability footprint). In Scenario 2 for example, about 30% similarity in inputs, 50% similarity in capability footprint, and 0% similarity in outputs. Collapsing claims editing functionality in Scenario 2 is going to be difficult and hence merging these systems into one consolidated system is questionable. In Scenario 3 however, the functionally collapsed system could look very different. More than 80% of data inputs are similar, about 33% of the outputs are similar, and 33% of the capability footprint is similar (e.g., claims editing). Collapsing the functionality of all three systems and eliminating functional redundancy of claims editing across all three systems is more compelling. Detection of functional similarities is possible by comparing outcome (consumed and produced data) of two or more functions. Two or more functions that produce and consume same data can be considered functionally similar.

3. The third factor is similarities of function behavior. It is possible to determine behavioral similarities by comparing performance of similar functions across systems. Analysis of common performance metric results in identifying similar and different behavior of functions. Thus, using performance metrics as a means for detecting functional similarities may be supplementary to semantic and syntactic analysis of functions. Performance metrics are defined to test the behavior and outcome of functions and the results indicative of a function's behavior. For example, a performance metric that tracks or monitors the number of medical claims edited or number of medical claims adjudicated is indicative of the system's functions. When a set of performance metrics is commonly defined and deployed across multiple systems, the results of the performance metrics can be used to find potentially redundant functions.

Thus, syntactic and semantic comparisons are used to determine functional similarities. Performance metrics may be used as a supplementary technique for finding potentially redundant functions.

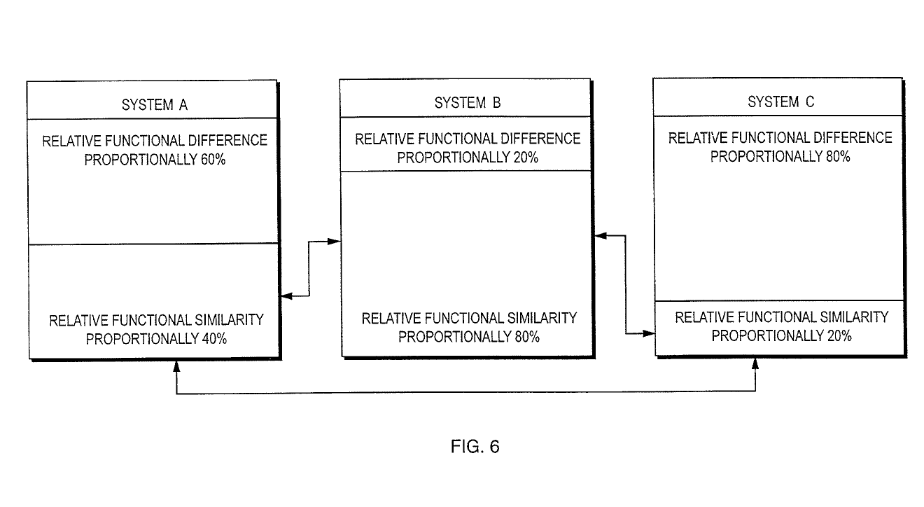

In addition, the method also measures the proportion of detected relative similarities and differences (byproduct of detecting similarities) within each functionally similar system (described above with reference to FIGS. 5A and 5B and Scenarios 1, 2 and 3). The detection of proportions helps solve the problem of determining technical and economic feasibility of eliminating redundancy and consolidating systems. FIG. 6 illustrates a hypothetical proportional distribution of functional similarities across three functionally similar systems. All the systems in this illustration may be standalone, non-interacting systems.

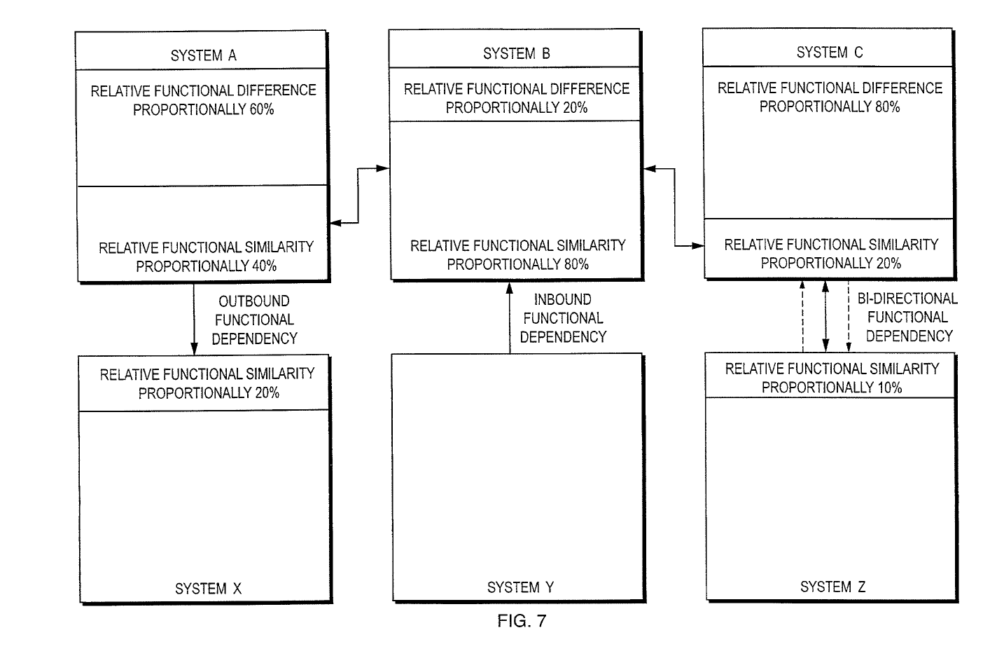

The disclosed method extends functional decomposition and detection of functional redundancy to include functional dependencies across systems. Functional dependencies arise when one system depends on another system(s) to perform its functions. FIG. 7 illustrates a hypothetical scenario where three functionally similar systems are interacting with other systems and each functionally similar system has a different type of functional dependency. In one embodiment, the types of dependencies include outbound functional dependency, inbound functional dependency, and bi-directional functional dependency. The disclosed method traverses every functional dependency associated with similar functions across consolidated systems.

The process or method for collapsing detected functional similarities across functionally similar, stand-alone and interacting systems includes the following steps, in one embodiment:

Step 1: Identify a cluster of functionally similar systems.

Step 2: Use the highest system abstraction model to categorize functional similarities across each systems functions into discrete categories:
Interfaces
Transactions
Dependencies
Services
Processes.

Step 3: Measure the proportion of each detected functional similarity relative to each system selected for consolidation.

Step 4: For each interacting system, traverse functional dependencies and categorize each dependency from the consolidated system's perspective. The categorization of dependencies includes, in one embodiment:
Inbound functional dependency (an external system depends on the consolidated system to perform its functions)
Outbound functional dependency (consolidated system depends on an external system to perform its functions)
Bi-directional functional dependency (consolidated system and external system depend on each other to perform different functions).

Step 5: Collapse each discrete functional similarity and associated functional dependencies into a new discrete, interacting, functionally non-redundant system. Collapsing means detecting relative similarities and differences and isolating them into non-redundant systems. Redundancy of a system is proportional to functional similarities. A high number of functional similarities leads to greater redundancy. Recursive collapsing of functions results in highly non-redundant systems. Since this process is relative to the systems being consolidated or targeted for consolidation, the likelihood of 100% non-redundant systems is also relative.

Collapsing functional similarities and consolidating functionally similar systems is a better approach than merging multiple systems into one common system especially when more than two functionally similar systems exist.

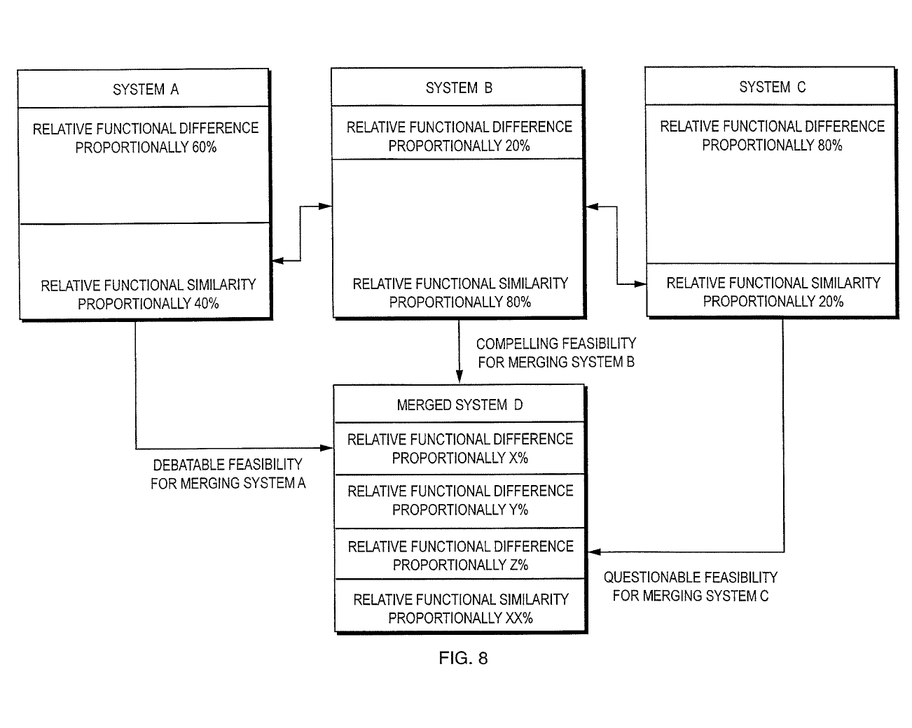

FIG. 8 illustrates the potential complexities of a merged system as well as the variations in technical and economic feasibility of merging functionally similar systems. In the hypothetical example, merging systems A and B may be feasible, but merging system C does not have the same feasibility. FIGS. 5A and 5B, described above, also illustrate this concept.

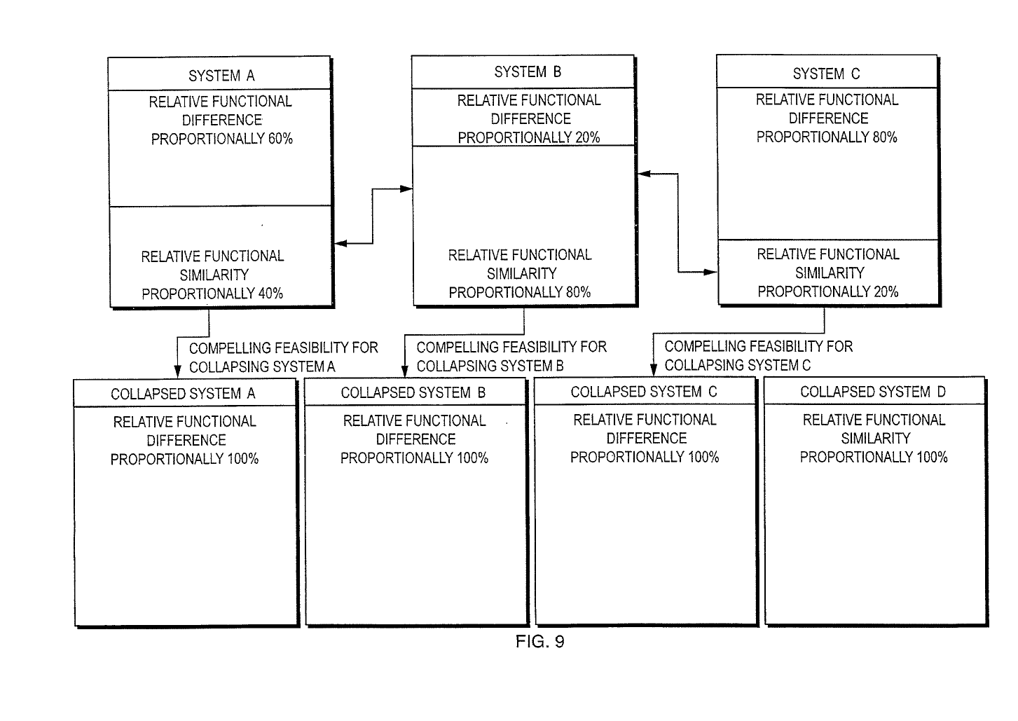

In contrast, FIG. 9 illustrates how the same systems A, B, and C have greater feasibility for consolidation when the relative differences in systems A, B, and C are isolated and the relative similarities are collapsed into a new system D. The collapsing method for system consolidation results in all collapsed systems A, B, C, and D being functionally unique. Recursive application of the method to functionally similar systems achieves 100% non-redundant systems. Thus, similar functions are taken from Systems A, B, and C and put into a new System D, which results in Systems A, B, C, and D being free from functional redundancy.

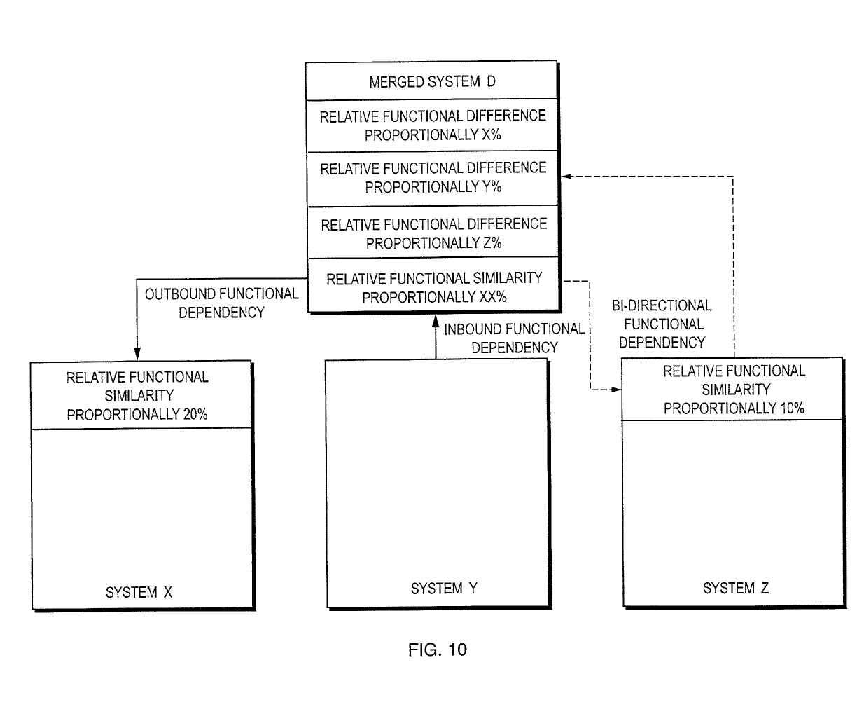

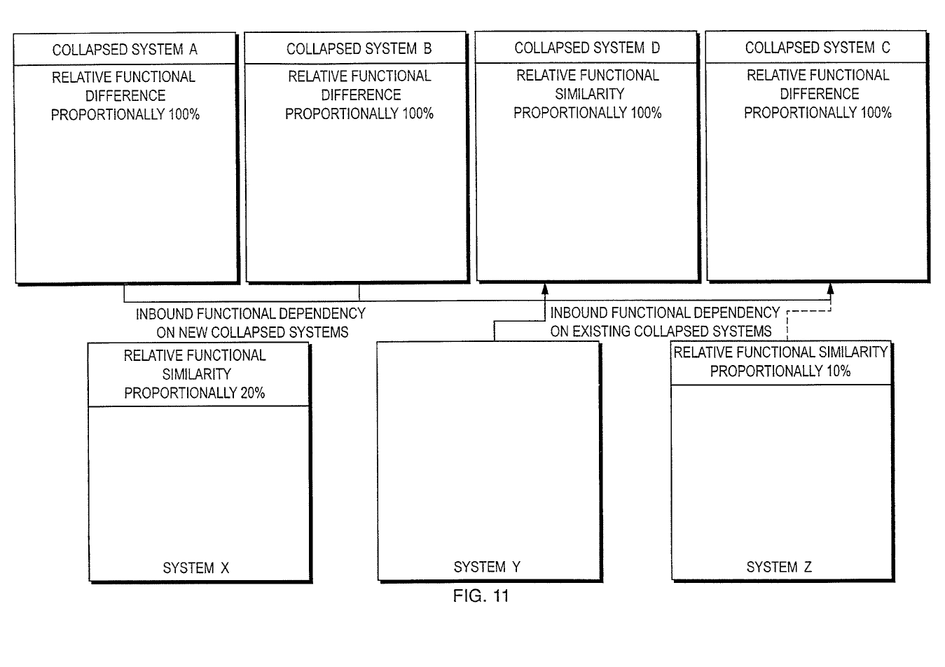

The same principles apply for collapsing interacting systems where there are functional dependencies between collapsed systems. FIG. 10 illustrates how merging functionally similar systems results in existing functional dependencies to persist and increase the ongoing complexity of the merged system. In contrast, FIG. 11 illustrates how collapsing functional dependencies in interacting systems results in eliminating outbound functional dependencies or simplifying functional dependencies across collapsed systems. The reduction in functional dependencies between systems is a significant factor in determining feasibility of systems for system consolidation. Thus, because the collapsed systems are functionally similar, their dependencies are also likely to be similar and, thus, less complicated and/or fewer in number. Scenario 3 of FIG. 5B illustrates this point.

The method is applicable to any system domain where functionally similar systems exist. The highest system abstraction model is capable of representing any known system for the purpose of detecting functional similarities and differences. Representing the system using the abstraction model may be, in some embodiments, an automated process or a partially manual process, the result of which being a capability footprint for each system (one footprint prior to functional collapsing and another footprint after functional collapsing).

The process of detecting functional similarities extends to include interacting systems and the functional dependencies between systems. Existing functional decomposition techniques do not specifically include interacting systems.

The result of applying this method recursively to functionally similar systems is, in some embodiments, complete elimination of functional redundancy. Thus, the method is applied not just to all functions within a system but also to the capability foot prints of all systems that are to be consolidated. With reference to the example described in FIG. 5B, Scenario 1, Scenario 2 and Scenario 3 are iterations of the functional collapsing process.

These three aspects of the disclosed method make the process of collapsing functionally similar systems economically and technically feasible.

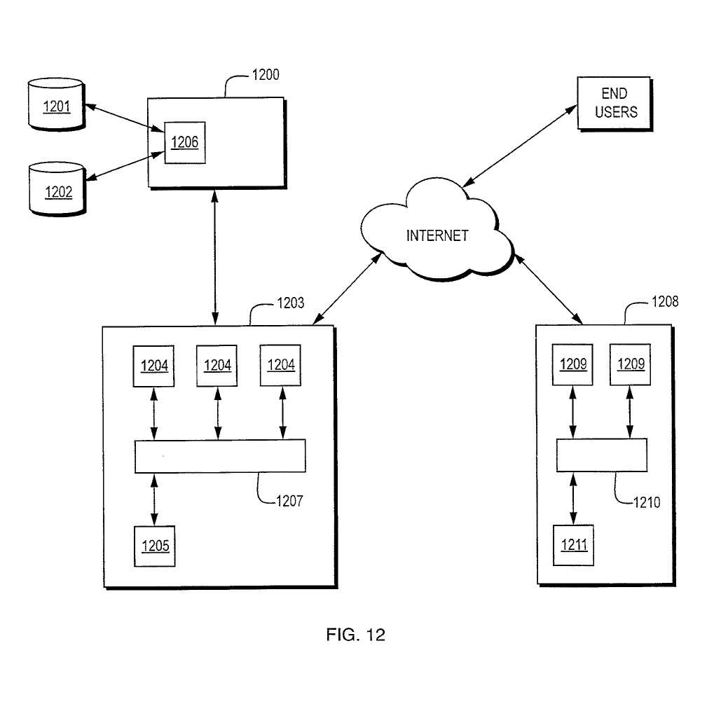

One or more of the steps of the methods described herein for collapsing functionally similar systems are carried out using computer processors specially programmed to perform such functionality. Exemplary hardware and software employed by the systems discussed herein are now generally described with reference to FIG. 12.

Database server(s) 1200 may include a database services management application 1206 that manages storage and retrieval of data from the database(s) 1201, 1202. The data that is stored in such databases may include, for example, the functions of the systems that are sought to be consolidated, the data that is consumed or produced by such functions, performance metrics of such functions, proportions of detected relative similarities and differences, and functional dependencies across systems. The databases may be relational databases; however, other data organizational structure may be used without departing from the scope of the present invention.

One or more application server(s) 1203 are in communication with the database server 1200. The application server 1203 communicates requests for data to the database server 1200. The database server 1200 retrieves the requested data. The application server 1203 may also send data to the database server for storage in the database(s) 1201, 1202. The application server 1203 comprises one or more processors 1204, computer readable storage media 1205 that store programs (computer readable instructions) for execution by the processor(s), and an interface 1207 between the processor(s) 1204 and computer readable storage media 1205. The application server may store the computer programs referred to herein (for example, the software that is used to carry out one or more of the steps for collapsing functionally similar systems).

To the extent data and information is communicated over the Internet (or an Intranet), one or more Internet (Intranet) servers 1208 may be employed. The Internet (Intranet) server 1208 also comprises one or more processors 1209, computer readable storage media 1211 that store programs (computer readable instructions) for execution by the processor(s) 1209, and an interface 1210 between the processor(s) 1209 and computer readable storage media 1211. The Internet (Internet) server 1208 is employed to deliver content that can be accessed through the communications network, e.g., by an end user. Thus, for example, a user-facing interface may be built that allows an end user to employ and control the functionality of the software described herein, and view its results. When data is requested through an application, such as a browser, the Internet server 1208 receives and processes the request. The Internet server (Intranet) 1208 sends the data or application requested along with user interface instructions for displaying a user interface.

The non-transitory computer readable storage media that store the programs (i.e., software modules comprising computer readable instructions) may include volatile and non-volatile, removable and non-removable media implemented in any method or technology for storage of information such as computer-readable instructions, data structures, program modules, or other data. Computer readable storage media may include, but is not limited to, RAM, ROM, Erasable Programmable ROM (EPROM), Electrically Erasable Programmable ROM (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computer system and processed.

It will be appreciated by those skilled in the art that changes could be made to the exemplary embodiments shown and described above without departing from the broad inventive concept thereof It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and features of the disclosed embodiments may be combined. Unless specifically set forth herein, the terms “a”, “an” and “the” are not limited to one element but instead should be read as meaning “at least one”.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

Further, to the extent that the method does not rely on the particular order of steps set forth herein, the particular order of the steps should not be construed as limitation on the claims. The claims directed to the method of the present invention should not be limited to the performance of their steps in the order written, and one skilled in the art can readily appreciate that the steps may be varied and still remain within the spirit and scope of the present invention.

What is claimed is:

1. A method, one or more steps of which are carried out by a computer system, comprising:
receiving data identifying two or more functionally similar systems;
identifying functional similarities across the two or more functionally similar systems;
grouping the functional similarities into one or more categories;
measuring a proportion of each of the grouped functional similarities relative to each of the two or more functionally similar systems;
based on the proportion of each of the grouped functional similarities, identifying a non-redundant system comprising at least some functionality from each of the two or more functionally similar systems.

2. The method of claim 1, wherein the one or more categories comprise one or more of system interfaces, system-generated transactions, system dependencies, system services, and system processes.

3. The method of claim 2 wherein the system dependencies comprise one of inbound functional dependency, outbound functional dependency, and bi-directional functional dependency.

4. A system comprising:
memory operable to store at least one program; and
at least one processor communicatively coupled to the memory, in which the at least one program, when executed by the at least one processor, causes the at least one processor to:
receive data identifying two or more functionally similar systems;
identify functional similarities across the two or more functionally similar systems;
group the functional similarities into one or more categories;
measure a proportion of each of the grouped functional similarities relative to each of the two or more functionally similar systems;
based on the proportion of each of the grouped functional similarities, identify a non-redundant system comprising at least some functionality from each of the two or more functionally similar systems.

5. The system of claim 4, wherein the one or more categories comprise one or more of system interfaces, system-generated transactions, system dependencies, system services, and system processes.

6. The system of claim 5 wherein the system dependencies comprise one of inbound functional dependency, outbound functional dependency, and bi-directional functional dependency.

7. A non-transitory computer-readable storage medium that stores instructions which, when executed by one or more processors, cause the one or more processors to perform a method comprising:
receiving data identifying two or more functionally similar systems;
identifying functional similarities across the two or more functionally similar systems;
grouping the functional similarities into one or more categories;
measuring a proportion of each of the grouped functional similarities relative to each of the two or more functionally similar systems;
based on the proportion of each of the grouped functional similarities, identifying a non-redundant system comprising at least some functionality from each of the two or more functionally similar systems.

8. The non-transitory computer-readable storage medium of claim 7, wherein the one or more categories comprise one or more of system interfaces, system-generated transactions, system dependencies, system services, and system processes.

9. The non-transitory computer-readable storage medium of claim 8 wherein the system dependencies comprise one of inbound functional dependency, outbound functional dependency, and bi-directional functional dependency.
